(19) United States
(12) Patent Application Publication
(10) Pub. No.: US 2019/0034548 A1
(43) Pub. Date: Jan. 31, 2019

(54) SELECTING A BROWSER TO LAUNCH A UNIFORM RESOURCE LOCATOR (URL)

(71) Applicant: International Business Machines Corporation, Armonk, NY (US)

(72) Inventors: Neeta V. Agrawal, Piscataway, NJ (US); Yuvaraj T. Patil, Bangalore (IN); Abhijit Singh, Bangalore (IN); Rashmi Singh, Bangalore (IN)

(21) Appl. No.: 15/660,028

(22) Filed: Jul. 26, 2017

(51) Int. Cl. G06F 17/30; G06F 3/0484

(52) U.S. Cl. CPC G06F 17/30902; G06F 17/30887; G06F 3/0484

(57) ABSTRACT

A method and system is provided for selecting an optimal browser to launch a URL via an iterative process. A distance is calculated between a value of a performance parameter for each browser and a mean of each cluster of browsers. Each browser is assigned to a cluster having the smallest distance. The mean of each cluster is re-determined. The iterative process continues until the mean of each cluster is identical to the immediately preceding mean of the cluster. Next, a cluster is chosen based on which cluster is closer to an origin point. An optimal browser is chosen from the chosen cluster based on which browser is closest to the origin point. A message is provided to a user to prompt the user to launch a website on the chosen browser and an action to launch the chosen browser to display the website is detected.

### TECHNICAL FIELD

The present invention relates to launching a uniform resource locator (URL) by a browser.

### BACKGROUND

A website is a collection of related web pages that includes multimedia content. The website is typically identified with a common domain name and is published on at least one web server. Public users can access the website via a public Internet Protocol (IP) network (e.g., the Internet) or a private local area network (LAN) by referencing a uniform resource locator (URL) that identifies the site. Users can access and view websites for numerous reasons, including educational reasons, entertainment reasons, as a means to gather local or worldwide news, gaming reasons, business reasons, and social networking reasons, among others.

### SUMMARY

In one embodiment, the present invention provides a method, and associated computer program product and computer system, executed on a computing device for predicting and selecting an optimal browser to launch a uniform resource locator (URL). One or more processors of the computing device receive a value of a performance parameter for each browser of a plurality of browsers with respect to each species of a variable. The one or more processors receive an assignment of the value of the performance parameter for each browser in a subset of the plurality of browsers as a mean for a cluster for a plurality of clusters of the browsers in the plurality of browsers. The one or more processors compare a distance between the value of the performance parameter for each browser and the mean of each cluster of the plurality of clusters to identify a smallest distance between each browser and each cluster. The one or more processors assign each browser to the cluster having the smallest distance for each browser and ascertain the mean of each cluster of the plurality of clusters. The one or more processors iteratively repeat the comparing step, the assigning step, and the ascertaining step for L iterations, where L is at least 1 and L is determined as the first iteration in which the mean of each cluster of the plurality of clusters is identical to the immediately preceding mean. After the L iterations have been performed, the one or more processors identify a chosen cluster from the plurality of clusters. The chosen cluster has a lesser distance between the mean of the plurality of clusters and an origin point. The one or more processors determine a chosen browser as having a shortest distance between each of the browsers located within the chosen cluster and the origin point. The one or more processors provide, in a feedback pane on a user interface, a message to prompt a user to launch a website on the chosen browser located within the chosen cluster. The one or more processors detect an action by the user to launch the chosen browser to display the website.

### BRIEF DESCRIPTION OF THE DRAWINGS

FIG. 1 is a block diagram of a cognitive analysis system for predicting and selecting a browser to launch a uniform resource locator (URL), in accordance with embodiments of the present invention.

FIG. 2A- FIG. 2C illustrate schematic diagrams/graphs to predict and select a browser to launch a uniform resource locator (URL), in accordance with embodiments of the present invention.

FIG. 3 is a flowchart of a process to select a browser to launch a uniform resource locator (URL), in accordance with embodiments of the present invention.

FIG. 4 is a block diagram of a computing device included within the cognitive analysis system of FIG. 1 and that implements the process of FIG. 3, in accordance with embodiments of the present invention.

### DETAILED DESCRIPTION

Users can encounter errors when accessing web pages, as web pages may only work on a specific set of browsers and some URLs may contain lengthy strings of numbers and letters that are difficult to memorize. As many web-based services may be browser-specific, these web-based services fail to provide a cognitive approach to choosing a preferable browser to open the URL. Further, though these web-based services allow for synchronization of bookmarks across different browser platforms, these solutions fail to resolve the problem of recalling which URL works on which specific browser.

Embodiments of the present invention provide a cognitive approach to predict and select an optimal browser to launch a URL. To determine which of the browsers can be used to launch the URL, the cognitive approach considers factors such as, but not limited to, a time period required to load the URL on each browser, a length of time associated with viewing the URL on each browser, a number of errors encountered while viewing the URL on each browser, a navigation frequency associated with navigating from each browser to another browser subsequent to encountering an error loading the URL on each browser, or a combination thereof. According to embodiments of the instant disclosure, the error includes a networking error, a processing error, a cache error, or a combination thereof. Embodiments of the present invention remedy problems involved with browser-specific services, which fail to include a cognitive approach to determining an optimal browser to open the URL.

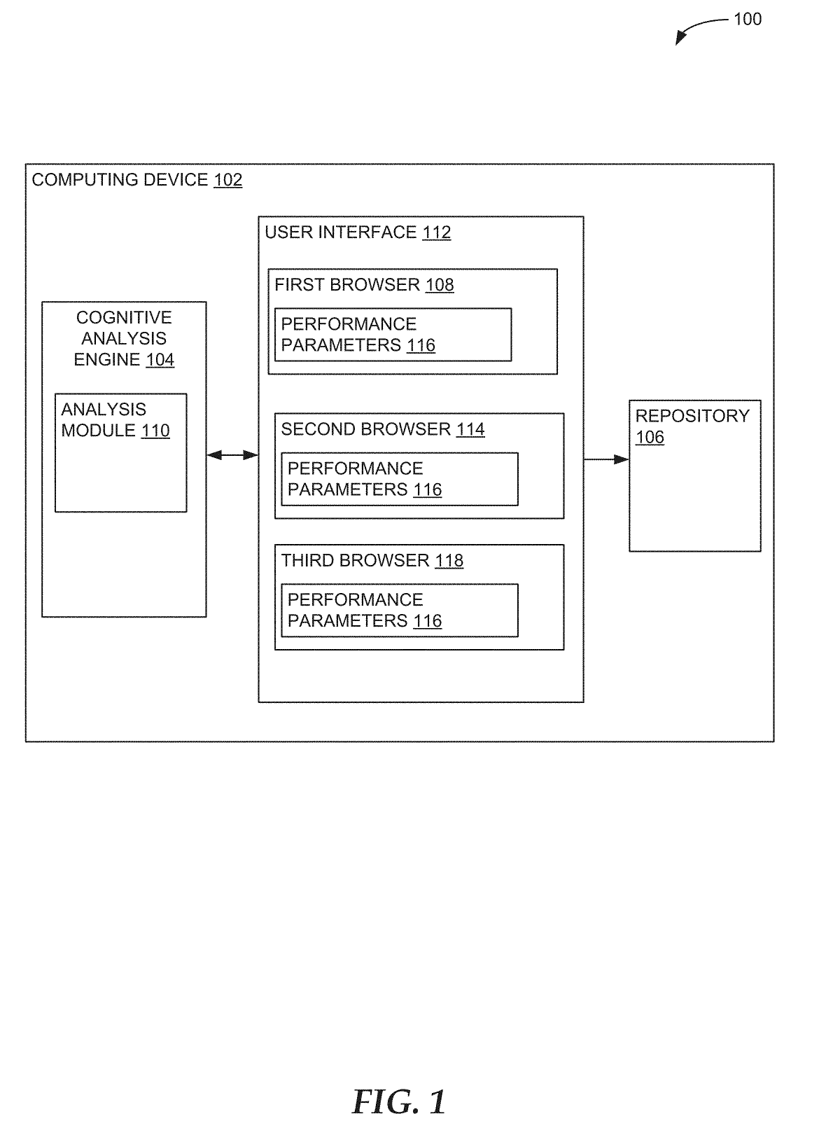

FIG. 1 is a block diagram of a cognitive analysis system for predicting and selecting a browser to launch a uniform resource locator (URL), in accordance with embodiments of the present invention.

The cognitive analysis system 100 includes a computing device 102, which executes a software-based cognitive analysis engine 104. The computing device 102 further includes a user interface 112 and a repository 106. The user interface 112 displays browsers. In a merely illustrative example, the user interface 112 displays three browsers a first browser 108, a second browser 114, and/or a third browser 118). The number of browsers is not limited to the value of three and may include a different numerical value per other embodiments of this present disclosure. The cognitive analysis engine 104 includes an analysis module 110, among other engines/modules. According to the illustrative example, the analysis module 110 interacts with the first browser 108, the second browser 114, and/or the third browser 118 displayed on the user interface 112.

According to embodiments of the instant disclosure, the cognitive analysis engine 104 receives performance information remotely from the computing device 102 of a user. In other examples, the cognitive analysis engine 104 retrieves the performance information, in real-time, from a web-based social network or a public forum, among additional sources, loaded on the last browser 108, the second browser 114, and/or the third browser 118.

As an illustrative example, the value of the performance parameters 116 include user-inputted numerical ratings of the first browser 108, the second browser 114, and the third browser 118 posted on social media, the web-based social network, and/or the public forum. The user-inputted numerical ratings of the first browser 108, the second browser 114, and the third browser 118 may be based on factors, such as a user's experience of launching the URL on the first browser 108, the second browser 114, and the third browser 118, respectively. The user's experience of launching the URL on the respective browsers may take into account the load time of the URL on the respective browser or visual/stylistic appeal of the URL being loaded on the specific browser, among other factors. A scale for the numerical ratings may include a scale from zero to five, with a rating of four or five being indicative of a positive user experience, a of two or three being indicative of a neutral user experience, and a rating of zero or one being indicative of a negative user experience associated with launch the URL on a specific browser. In an example, the user has a positive experience while launching the URL on the third browser 118 and posts a rating of four for the third browser 118. If the user has a negative experience while launching the URL on the first browser 108, based on the same factors, the user may post a rating of zero for the first browser 108. If the user has a neutral experience while launching the URL on the second browser 114, based on the same factors, the user may post a rating of two for the second browser 114.

The performance information includes performance parameters 116. In embodiments of the instant disclosure, the performance parameters 116 for each of the first browser 108, the second browser 114, and the third browser 118 include a time period required to load the URL on each browser, a length of time associated with viewing the URL on each browser, a number of errors encountered while viewing the URL on each browser, a rating of each browser obtained from members of one or more social networks, a navigation frequency associated with navigating from each browser to another browser subsequent to encountering an error loading the URL on each browser, or a combination thereof. According to embodiments, the error includes a networking error, a processing error, a cache error, or a combination thereof.

In an example, the user may be playing a web-based game on the first browser 108 and may come across the error or a computer problem that may hinder the gaming experience. The user may be unaware of which browser (e.g., the second browser 114 or the third browser 118) to choose to continue playing the game without the error or the computer problem. In some examples, the cognitive analysis engine 104 may identify the navigation frequency associated with navigating from the first browser 108 to the second browser 114 subsequent to encountering the error (e.g., an HTTP 301 error) while loading the on the first browser 108.

In embodiments, the performance parameters 116 are recorded at run-time during a first time period when the user launches the URL on the first browser 108 and are referenced when the URL is launched during a second time period on the first browser 108. The cognitive analysis engine 104 stores the performance parameters 116 in the repository 106. The repository 106 includes an identify target entity repository, an opinion repository, a feedback repository, or a decision making repository,among others.

In further examples, the analysis module 110 identifies a value of each of the performance parameters 116 for each browser with respect to each species of M species a variable, where M≥2. The value of M is not limited to being greater than or equal to two and may include other numerical values according to other embodiments of the instant disclosure. The value of each of the performance parameters 116 for each browser with respect to each species of the variable is also stored in the repository 106. According to embodiments, the value of each of the performance parameters 116 for each browser with respect to each species includes unweighted data points.

According to other embodiments, the value of each of the performance parameters 116 for each browser with respect to each species includes weighted data points. In an example, the weighting of the data points may be based on user ratings posted on the web-based social network or online public forum associated with each of the browsers. As described previously, if during a first time period, the user has a positive user experience loading the URL on the first browser 108, the user may post a rating of four or five on the web-based social network. If, during the first time period, the user has a negative user experience while loading the URL on the second browser 114, the user may post a rating of zero or one on the web-based social network. During a second time period, the value of the performance parameter 116 for the first browser 108 will be weighted greater than the value of the performance parameter 116 for the second browser 114. As such, the cognitive analysis engine may prompt the user to launch the URL on the first browser 108 during the second time period.

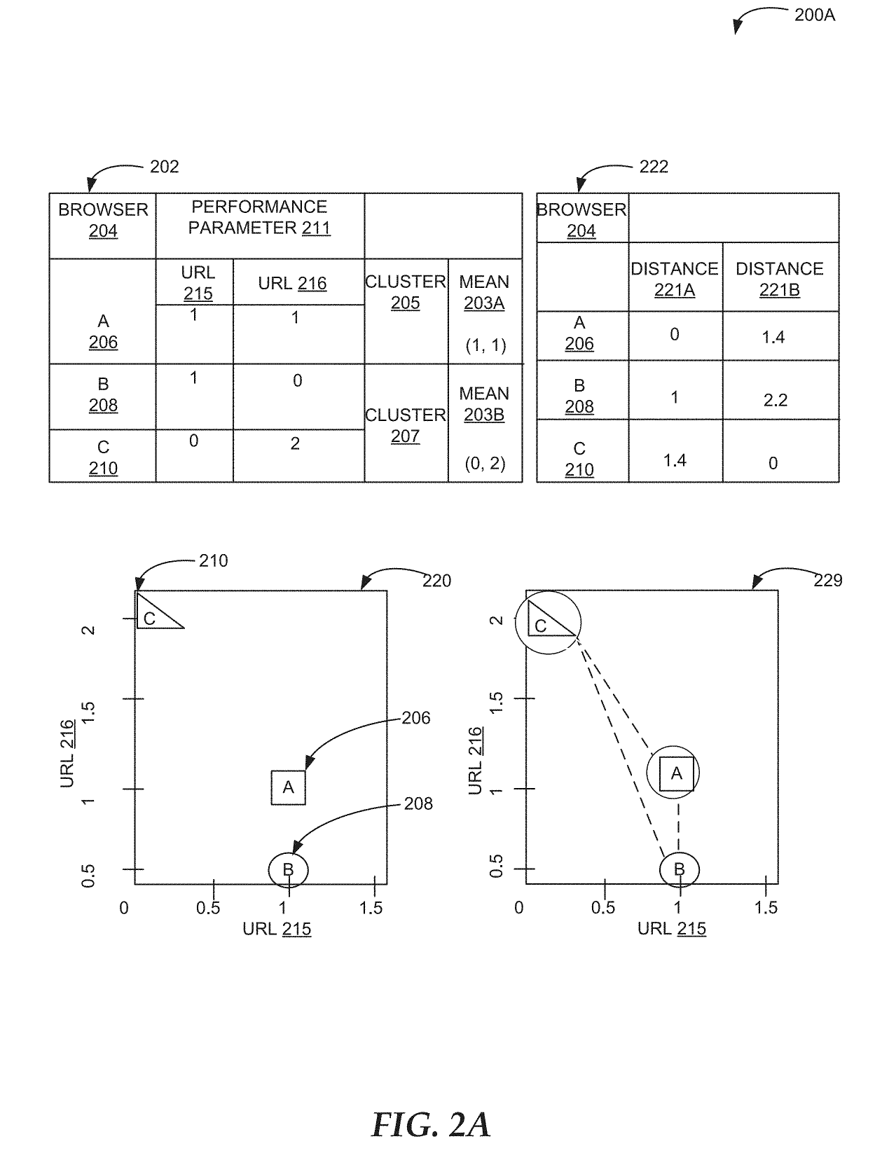

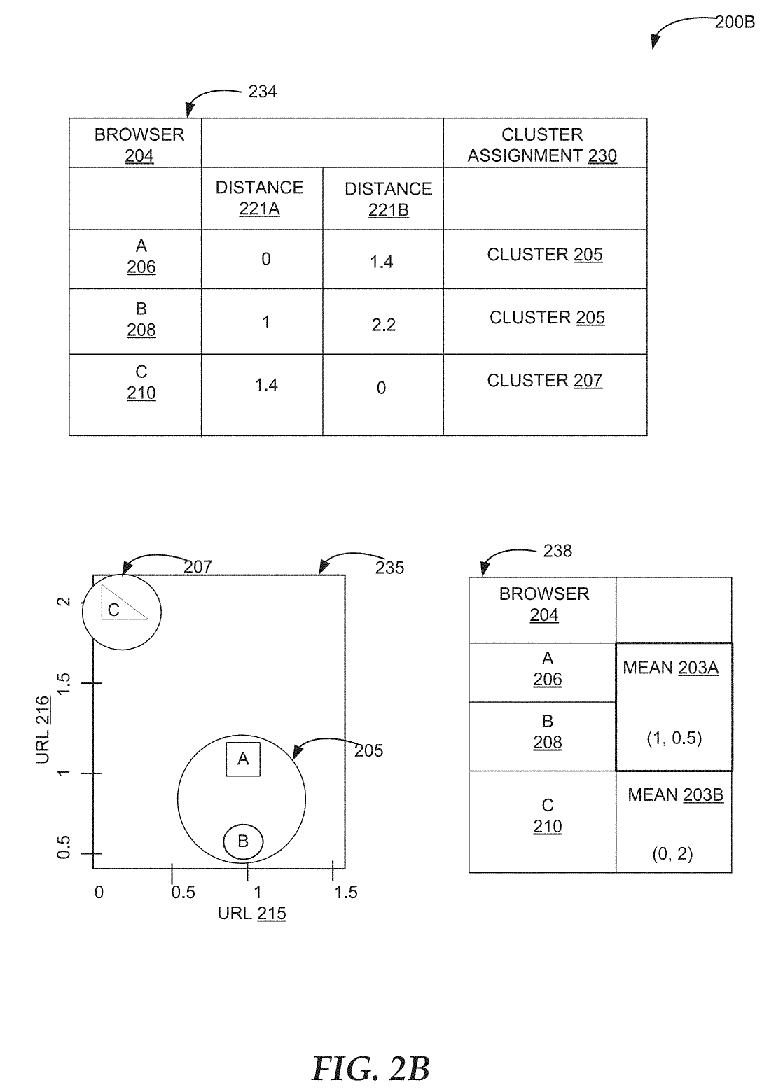

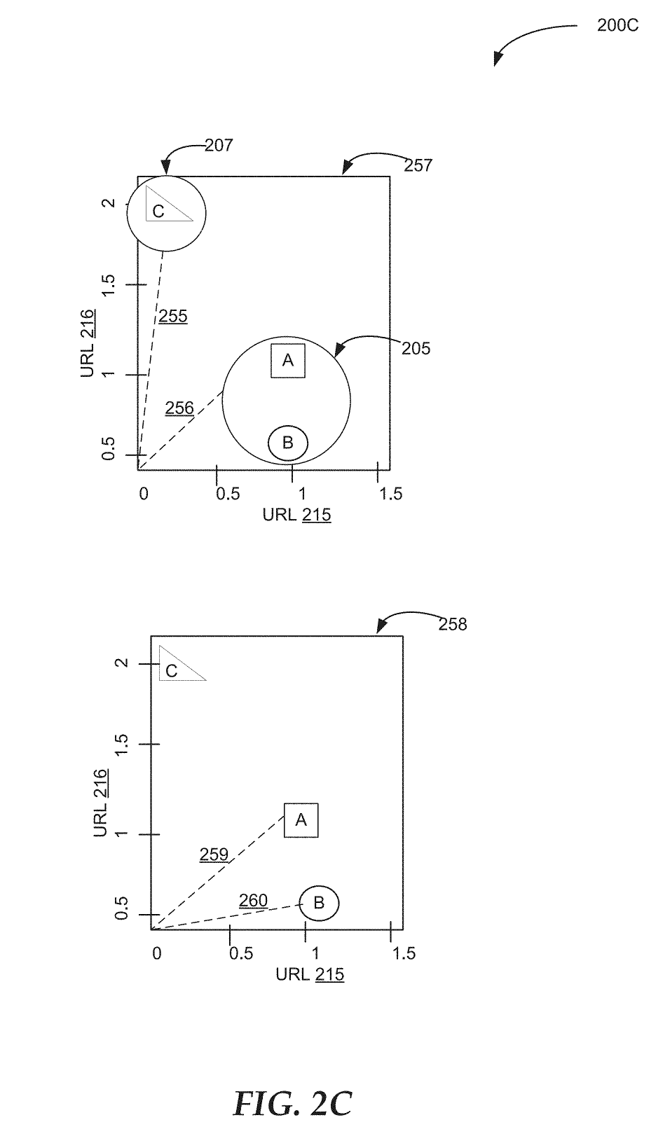

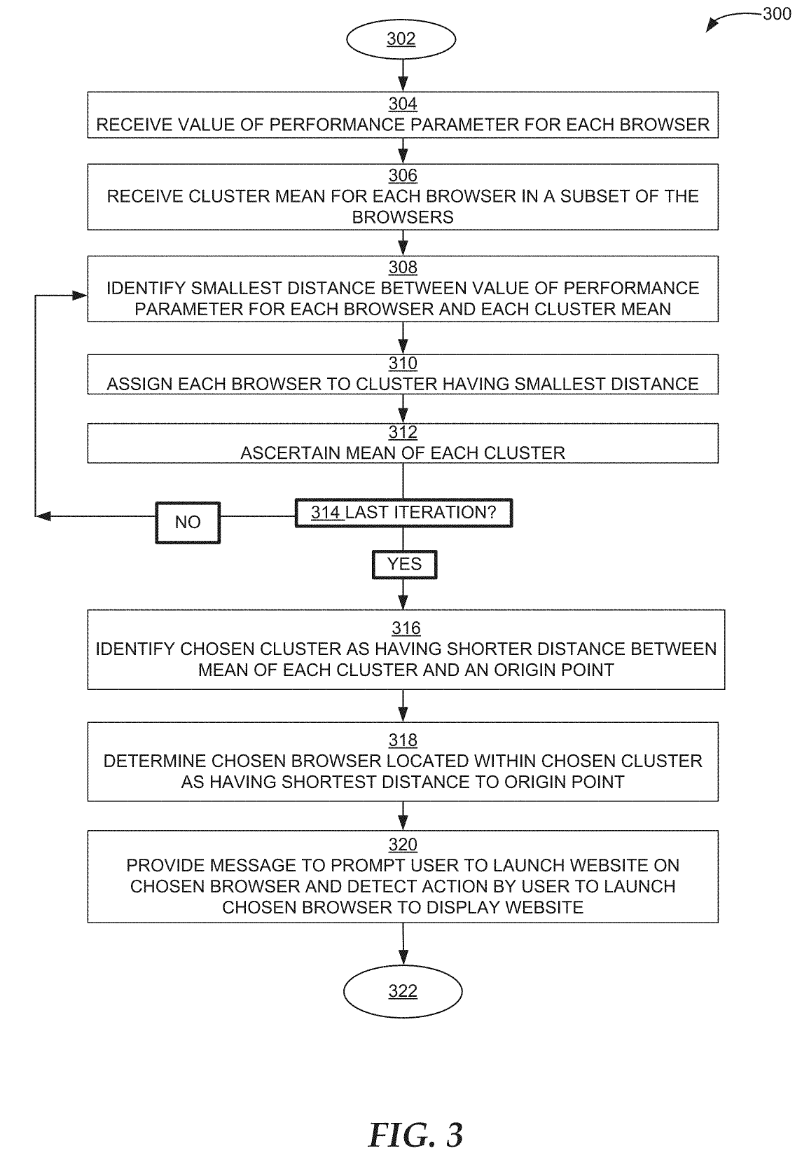

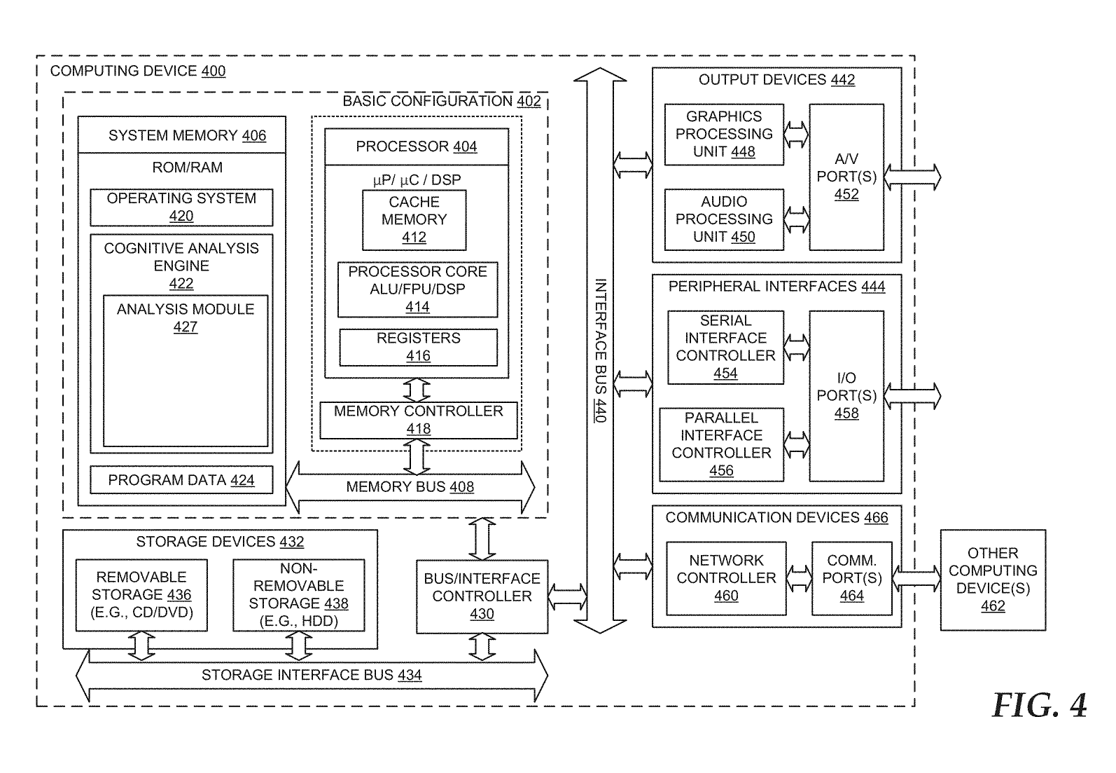

The functionality of the components shown in FIG. 1 is described in more detail in the discussion of FIG. 2A-2D, FIG. 3, and FIG. 4 presented below.

FIG. 2A- FIG. 2C illustrate schematic diagrams/graphs to predict and select a browser to launch a uniform resource locator (URL), in accordance with embodiments of the present invention.

According to an illustration 200A in FIG. 2A, a chart 202 displays values of received performance parameters 211 for several browsers 204, including browser A 206, browser B 208, and browser C 210. The chart 202 is merely illustrative and is not limited to displaying the three browsers, the browser A 206, the browser B 208, and the browser C 210. As a merely illustrative example, the performance parameters 211 are a load time (e.g., in milliseconds) to load a URL 215 on each of the browsers 204 and to load a URL 216 on each of the browsers 204. The load time may be measured in other time frames, such as seconds or minutes, among other examples. In this example, the independent variables include the multiple URL's (e.g., the URL 215 and the URL 216).

According to an example deemed merely illustrative and non-exhaustive, a value of the performance parameter 211 associated with launching the URL 215 on the browser A 206 is 1 ms and the value of the performance parameter 211 associated with launching the URL 216 on the browser A 206 is 1 ms. The value of the performance parameter 211 associated with launching the URL 215 on the browser B 208 is 1 ms and the value of the performance parameter 211 associated with launching the URL 216 on the browser B 208 is 0 ms. The value of the performance parameter 211 associated with launching the URL 215 on the browser C 210 is 0 ms and the value of the performance parameter 211 associated with launching the URL 216 on the browser C 210 is 2 ms.

Further, other performance parameters 211 may be analyzed for each of the browsers 204, such as: a time period required to load the URL on each browser, a length of time associated with viewing the URL on each browser, a number of errors encountered while viewing the URL on each browser, a navigation frequency associated with navigating from each browser to another browser subsequent to encountering an error loading the URL on each browser, or a combination thereof. According to some examples, the number of errors encountered while viewing the URL on each browser is a number of a specific type of error (e.g., an HTTP 301 error) encountered while viewing each browser during a time period,

Next, the cognitive analysis engine 104 (of FIG. 1) receives an assignment of the value of the performance parameter for each browser in a subset of the plurality of browsers as a mean for a cluster for a plurality of clusters of the browsers in the plurality of browsers. For example, the cognitive analysis engine 104 (of FIG. 1) receives an assignment of the value of the performance parameter 211 associated with launching the URL 215 on the browser A 206 and the value of the performance parameter 211 associated with launching the URL 216 on the browser A 206 (e.g., [1, 1]) as a mean 203A of a cluster 205 of K clusters of browsers, where K=2. The numerical value of K is not limited to the value of two and may include differing numerical values according to other embodiments of this present disclosure.

According to some embodiments, a numerical value for K is selected randomly. In other examples, the numerical value for K is selected responsive to: providing, in a feedback pane on the user interface 112 (of FIG. 1) of the computing device 102 (of FIG. 1), another message to prompt the user to input the numerical value associated with K and receiving the numerical value associated with K from the user. In some embodiments, the other message is displayed to the user via a pop-up (including text and/or graphics) on the user interface 112 of the computing device 102 (of FIG. 1).

According to embodiments of the present invention, the mean 203A encompasses a first performance parameter with respect to all species of M species of the variable (e.g., the URL 215 and the URL 216), where M≥2. According to examples, the numerical value associated with M is not limited to being greater than or equal to two. The cognitive analysis engine 104 (of FIG. 1) additionally receives another assignment of the value of the performance parameter 211 associated with launching the URL 215 on the browser C 210 and the value of the performance parameter 211 associated with launching the URL 216 on the browser C 210 (e.g., [0, 2]) as a mean 203B of a cluster 207 of the K clusters. In some embodiments, the mean 203B also encompasses a second performance parameter with respect to all species of the M species of the variable.

A graph 220 of FIG. 2A displays an x-axis associated with the values of the performance parameters 211 (measured in milliseconds in this illustrative example) for the URL 215 and a y-axis associated with the values of the performance parameters 211 (measured in ms in this illustrative example) for the URL 216. The browser A 206, the browser B 208, and the browser C 210 are displayed on the graph 220.

In some embodiments of the present disclosure, as displayed in a chart 222 of FIG. 2A, the cognitive analysis engine 104 (of FIG. 1) also calculates a distance 221A between the value of the performance parameter 211 for each of the browsers 204 (e.g., the browser A 206, the browser B 208, and the browser C 210) and the mean 203A for the cluster 205.

The mean 203A of the cluster 205 is calculated by measuring the mean of the value of the performance parameter 211 for each of the browsers 204 with respect to each species of M species of the variable. As an illustrative and non-exhaustive example, the browser A 206 and the browser B 208 are located within the cluster 205. The value of the performance parameter 211 for the URL: 215 for browser A 206 is 1. The value of the performance parameter 211 for the URL 215 for browser B 208 is 1. As such, the x-value for the mean 203A of the browser A 206 and the browser B 208 located within the cluster 205 is calculated as:

$$\frac{{X}_{1 A} + {X}_{1 B}}{2} \qquad Equation 1$$

where X_{1A} is the value of the performance parameter 211 for the URL 215 or the browser A 206 and

X_{1B} is the value of the performance parameter 211 for the URL 215 for the browser B 208.

Following Equation 1 above, the x-value for the mean 203A of the browser A 206 and the browser B 208 located within the cluster 205 is calculated as:

$$\frac{1 + 1}{2} = 1$$

Further, assuming the performance parameter 211 for the URL 215 for the browser A 206 is 1 and the value of the performance parameter 211 for the URL 215 for the browser B 208 is 0, the y-value for the mean 203A of the browser A 206 and the browser B 208 located within the cluster 205 is calculated using Equation 1 above, however, X_{1A} is the value of the performance parameter 211 for the URL 216 for the browser A 206 and X_{1B} is the value of the performance parameter 211 for the URL 216 for the browser B 208. Following this formula, the y-value for the mean 203A of the browser A 206 and the browser B 208 located within the cluster 205 is calculated as:

$$\frac{1 + 0}{2} = 0.5$$

As such, the mean 203A for the cluster 205 (which includes the browser A 206 and the browser B 208) is: [1, 0.5].

According to some embodiments, the method to determine the distance 221A and the distance 221B includes minimizing a within-cluster sum of squares (WCSS) and thus, the cognitive analysis engine 104 (of FIG. 1) assigns the least sum of squares. The least sum of squares is equivalent to assigning each of the browsers 204 to the cluster 205 the cluster 207 based on the smallest Euclidean distance between the value of the performance parameter 116 for each of the browsers 204 and the mean of each cluster. The Euclidean distance is computed by the following formula:

{square root over ([X1−M1)²+(X2−M2)²)} Equation 2

where X1 is the value of the performance parameter 211 for the URL 215 with respect to each species of M species of a variable,

X2 is the value of the performance parameter 211 for the URL 216 with respect to each species of M species of a variable,

M1 is the mean 203A, and

M2 is the mean 203B.

For example, using preceding Equation 2 in paragraph 31 and taking browser A 206, the X1 value or the value of the performance parameter 211 for the URL 215 is 1 ms, the X2 value or the value of the performance parameter 211 for the URL 216 is 1 ms, the M1 or the mean 203A is (1, 1), and the M2 or the mean 203B is (0, 2). Given these inputs, the distance 221A for the browser A 206 is:

\sqrt{[(1−1)²+(1−1)²=0}

Based on this calculation, the browser A 206 has the distance 221A of 0, the browser B 208 has the distance 221A of 1, and the browser C 210 has the distance 221A of 1.4. Further, the cognitive analysis engine 104 also calculates a distance 221B between the value of the performance parameter 211 for each of the browsers 204 (e.g., the browser A 206, the browser B 208, and the browser C 210) and the mean 203B for the cluster 207. Based on this calculation, the browser A 206 has the distance B of 1.4, the browser B 208 has the distance 221B of 2.2, and the browser C 210 has the distance 221B of 0.

A graph 229 of FIG. 2A displays the x-axis associated with the value of the performance parameters 211 for the URL 215. The graph 229 also displays the y-axis associated with the value of the performance parameters 211 for the URL 216. The browser A 206, the browser B 208, and the browser C 210 are displayed on the graph 229. Further, the calculated distances are displayed between each of the browsers 204 (e.g., the browser A 206, the browser B 208, and the browser C 210) and the mean 203A of the cluster 205 (e.g., [1, 1]). The calculated distances are also shown between each of the browsers 204 (e.g., the browser A 206, the browser B 208, and the browser C 210) and the mean 203B of the cluster 207 (e.g., [0, 2]).

According to an illustration 200B in FIG. 2B, a chart 234 is depicted. The cognitive analysis engine 104 (of FIG. 1) compares the distance between the value of the performance parameter for each browser and the mean of each cluster of the plurality of clusters to identify a smallest distance between each browser and each cluster. In an illustrative example, the cognitive analysis engine 104 (of FIG. 1) compares the distance 221A for each of the browsers 204 (e.g., the browser A 206, the browser B 208, and the browser C 210) to the distance 221B for each of the browsers 204 (e.g., the browser A 206, the browser B 208, and the browser C 210) to determine which distance is the smaller distance. Based on an identification of the smaller distance, the cognitive analysis engine 104 (of FIG. 1) performs a cluster assignment 230 to assign each of the browsers 204 to the cluster having the smallest distance. In the illustrative example, the cognitive analysis engine 104 (of FIG. 1) assigns each of the browsers 204 to either the cluster 205 or the cluster 207 based on which distance is smaller.

For example, the distance 221A for the browser A 206 is 0 and the distance 221B for the browser A is 1.4. As the distance 221A for the browser A 206 is smaller than the distance 221B, the cognitive analysis engine 104 (of FIG. 1) assigns the browser A 206 to the cluster 205. In other examples, the distance 221A for the browser B 208 is 1 and the distance 221B for the browser B 208 is 2.2. As the distance 221A for the browser B 208 is smaller than the distance 221B, the cognitive analysis engine 104 (of FIG. 1) assigns the browser B 208 to the cluster 205. In additional examples, the distance 221A for the browser C 210 is 1.4 and the distance 221B for the browser C 210 is 0. As the distance 221B for the browser C 210 is smaller than the distance 221A, the cognitive analysis engine 104 (of FIG. 1) assigns the browser C 210 to the cluster 207.

According to some examples, if the distance 221A and the distance 221B are identical for one of the browsers 204 (e.g., the browser A 206), the cognitive analysis engine 104 (of FIG. 1) will assign the browser A 206 to the cluster 205 or the cluster 207 randomly. In other examples, if the distance 221A and the distance 221B are identical for one of the browsers 204 (e.g., the browser A 206), the cognitive analysis engine 104 (of FIG. 1) assigns the browser A 206 to the cluster 205 or the cluster 207 based on past historical assignments of the browser A 206 to the cluster 205 or the cluster 207. For example, if during a first time period, the distance 221A and the distance 221B are identical for the browser A 206, the cognitive analysis engine 104 (of FIG. 1) assigns the browser A 206 to the cluster 205, then, during a second time period, the cognitive analysis engine 104 (of FIG. 1) assigns the browser A 206 to the cluster 205. In alternative embodiments, if the distance 221A (of FIG. 2A) for the browser A 206 (of FIG. 2A) is greater than or equal to the distance 221B (of FIG. 2A) (e.g., the distance 221A≥the distance 221B), the cognitive analysis engine 104 (of FIG. 1) will assign the browser A 206 to the cluster 205 (of FIG. 2A). If the distance 221A (of FIG. 2A) for the browser A 206 (of FIG. 2A) is less than the distance 221B (of FIG. 2A) (e.g., the distance 221A<the distance 221B), the cognitive analysis engine 104 (of FIG. 1) will assign browser A 206 to the cluster 207 (of FIG. 2A).

A graph 235 of FIG. 2B displays the x-axis associated with the value of the performance parameters 211 for the URL 215 and the y-axis associated with the value of the performance parameters 211 for the URL 216. The browser A 206, the browser B 208, and the browser C 210 are displayed on the graph 235. Further, each of the browsers 204 is assigned to the nearest cluster. For example, the browser C 210 is assigned to the cluster 207. The browser A 206 and the browser B 208 are assigned to the cluster 205.

According to FIG. 2B, a chart 238 is displayed. The cognitive analysis engine 104 (of FIG. 1) then ascertains a mean 203A of the cluster 205 and also ascertains a mean 203B of the cluster 207. Thus, the mean 203A for the cluster 205 is (1, 0.5) and the mean 203B of the cluster 207 is (0, 2). Next, the cognitive analysis engine 104 (of FIG. 1) iteratively repeats several process steps for L iterations, where L is at least 1. According to examples of the present disclosure, L is determined as the first iteration in which the mean 203A and the mean 203B are identical to the immediately preceding means, respectively. Once the iterative process has converged (e.g., the mean 203A and the mean 203B are identical to the immediately preceding means, respectively), the process moves onto an illustration 200C displayed in FIG. 2C.

According to embodiments of the instant disclosure, when, during one or more iterations of the L iterations, the cognitive analysis engine 104 identifies the mean 203A and the mean 203B as varying from the immediately preceding first mean and the immediately preceding ascertained second mean, respectively, the cognitive analysis engine 104 performs the following process steps: re-calculating the distance 221A between the value of the performance parameter 211 for each of the browsers 204 and the mean 203A of the cluster 205; re-calculating the distance 221B between the value of the performance parameter 211 for each of the browsers 204 and the mean 203B of the cluster 207; comparing the distance 221A and the distance 221B for each of the browsers 204 to identify the distance 221A or the distance 221B as being a briefest distance for each of the browsers 204; and re-assigning each of the browsers 204 to the cluster 205 or the cluster 207 if the cluster 205 or the cluster 207 is the briefest distance, respectively.

According to an illustration 200C in FIG. 2C, a graph 257 and a graph 258 are depicted. The graph 257 displays an x-axis associated with the value of the performance parameters 211 for the URL 215 and a y-axis associated with the value of the performance parameters 211 for the URL 216. The browser A 206, the browser B 208, and the browser C 210 are displayed on the graph 257. Further, the cluster 205 and the cluster 207 are displayed on the graph 257. The cluster 205 includes the browser A 206 and the browser B 208. The cluster 207 includes the browser C 210.

After the L iterations have been performed, as described in FIG. 2B, the cognitive analysis engine 104 (of FIG. 1) performs several process steps. First, the cognitive analysis engine 104 calculates a distance 256 (e.g., the Euclidean distance as described in Equation 2 of paragraph 30) between the mean 203B of the cluster 205 and an origin point. The cognitive analysis engine 104 also calculates a distance 255 (e.g., the Euclidean distance as described in Equation 2 of paragraph 30) between the mean 203B of the cluster 207 and the origin point Then, the cognitive analysis engine 104 compares the distance 256 and the distance 255 to identify the distance 256 or the distance 255 as being a lesser distance. Next, the cognitive analysis engine 104 identifies a chosen cluster associated with the distance 256 or the distance 255 if the distance 256 or the distance 255 is the lesser distance, respectively. As an example, the cognitive analysis engine 104 then identifies the distance 256 as being less than the distance 255 and then selects the cluster 205 as the chosen cluster.

The cognitive analysis engine 104 then identifies each of the browsers 204 located within the chosen cluster. In this illustrative example, the browser A 206 and the browser B 208 are located within the chosen cluster (e.g., the cluster 205). Then, the cognitive analysis engine 104 calculates a chosen browser as having a shortest distance (e.g., the Euclidean distance as described in Equation 2 of paragraph 30) between each of the browsers (e.g., the browser A 206 and the browser B 208) located within the chosen cluster (e.g., the cluster 205) and an origin point. According to this illustrative example, the cognitive analysis engine 104 identifies the browser B 208 as being closer to the origin point and having the shortest distance.

Responsive to this determination, the cognitive analysis engine 104 (of FIG. 1) provides, in a feedback pane on the user interface 112 (of FIG. 1), a message to prompt a user to launch a website on the chosen browser (e.g., the browser B 208) located within the chosen cluster (e.g., the cluster 205). The cognitive analysis engine 104 (of FIG. 1) then detects an action by the user to launch the chosen browser (e.g., the browser B 208) to display the website. The chosen browser is launched with the associated visual themes, extensions, plug-ins, and bookmarks of the browser B 208.

Further, in response to detecting the action by the user to launch the chosen browser (e.g., the browser B 208) to display the website, the cognitive analysis engine 104 (of FIG. 1) identifies the chosen browser as uninstalled on the computing device 102 (of FIG. 1) and prompts, in the feedback pane, the user to install the chosen browser. Additionally, the cognitive analysis engine 104 (of FIG. 1) detects another action by the user to install the chosen browser and detects an additional action by the user to launch the chosen browser to display the website.

FIG. 3 is a flowchart of a process to select a browser to launch a uniform resource locator (URL), in accordance with embodiments of the present invention.

The process of FIG. 3 begins at a step 302. The step 302 is followed by a step 304, where the cognitive analysis engine 104 (of FIG. 1) receives a value of a performance parameter for each browser of a plurality of browsers with respect to each species of a variable. In embodiments, performance information includes the value of the performance parameter. The performance parameter for each browser includes: a time period required to load the URL on each browser, a length of time associated with viewing the URL on each browser, a number of errors encountered while viewing the URL on each browser, a rating of each browser obtained from members of one or more social networks, a navigation frequency associated with navigating from each browser to another browser subsequent to encountering an error loading the URL on each browser, or a combination thereof. In some embodiments, the error includes a networking error, a processing error, a cache error, or a combination thereof. Additionally, according to some embodiments, the value of the performance parameter for each browser with respect to each species includes unweighted data points or weighted data points.

The step 304 is followed by a step 306, where the cognitive analysis engine 104 (of FIG. 1) receives an assignment of the value of the performance parameter for each browser in a subset of the plurality of browsers as a mean for a cluster for a plurality of clusters of the browsers in the plurality of browsers. In some embodiments of the instant disclosure, the assignments occur randomly.

The step 306 is followed by a step 308, where the cognitive analysis engine 104 (of FIG. 1) compares a distance between the value of said performance parameter for each browser and the mean of each cluster of the plurality of clusters to identify a smallest distance between each browser and each cluster. The distances are measured as Euclidean distances, as described in Equation 2 in paragraph 30.

According to some examples, if the distance 221A and the distance 221B are identical for one of the browsers 204 (e.g., the browser A 206), the cognitive analysis engine 104 (of FIG. 1) will assign the browser A 206 to the cluster 205 or the cluster 207 randomly. In other examples, if the distance 221A and the distance 221B are identical for one of the browsers 204 (e.g., the browser A 206), the cognitive analysis engine 104 (of FIG. 1) assigns the browser A 206 to the cluster 205 or the cluster 207 based on past historical assignments of the browser A 206 to the cluster 205 or the cluster 207. For example, if during a first time period, the distance 221A and the distance 221B are identical for the browser A 206, the cognitive analysis engine 104 (of FIG. 1) assigns the browser A 206 to the cluster 205, then, during a second time period, the cognitive analysis engine 104 (of FIG. 1) assigns the browser A 206 to the cluster 205. In alternative embodiments, if the distance 221A (of FIG. 2A) for the browser A 206 (of FIG. 2A) is greater than or equal to the distance 221B (of FIG. 2A) (e.g., the distance 221A≥the distance 221B), the cognitive analysis engine 104 (of FIG. 1) will assign the browser A 206 to the cluster 205 (of FIG. 2A). If the distance 221A (of FIG. 2A) for the browser A 206 (of FIG. 2A) is less than the distance 221B (of FIG. 2A) (e.g., the distance 221A<the distance 221B), the cognitive analysis engine 104 (of FIG. 1) will assign browser A 206 to the cluster 207 (of FIG. 2A),

The step 308 is followed by a step 310, where the cognitive analysis engine 104 (of FIG. 1) assigns each browser to the cluster having the smallest distance for each browser. The step 310 is followed by a step 312, where the cognitive analysis engine 104 (of FIG. 1) ascertains the mean of each cluster of the plurality of clusters using Equation 1 of paragraph 29.

The step 312 is followed by a step 314, where the cognitive analysis engine 104 (of FIG. 1) iteratively repeats the comparing step (the step 308), the assigning step (the step 310), and the ascertaining step (the step 312) for L iterations, where L is at least 1, and where L is determined as the first iteration in which the mean of each cluster of the plurality of clusters is identical to the immediately preceding mean. If the first and second mean are identical to the immediately preceding first mean and second mean, respectively, the cognitive analysis engine 104 (of FIG. 1) proceeds to a step 316.

The step 314 is followed by a step 316, where, after the L iterations have been performed, the cognitive analysis engine 104 (of FIG. 1) identifies a chosen cluster from the plurality of clusters, where the chosen cluster has a lesser distance between the mean of the plurality of clusters and an origin point.

The step 316 is followed by a step 318, where the cognitive analysis engine 104 (of FIG. 1) determines a chosen browser as having a shortest distance between each of the browsers located within the chosen cluster and the origin point.

The step 318 is followed by a step 320, where the cognitive analysis engine 104 (of FIG. 1) provides, in a feedback pane on a user interface, a message to prompt a user to launch a website on the chosen browser located within the chosen cluster. The step 320 is followed by a step 322, where the cognitive analysis engine 104 (of FIG. 1) detects an action by the user to launch the chosen browser to display the website.

A step 322 follows the step 320, which concludes the process.

FIG. 4 is a block diagram of a computing device included within the cognitive analysis system of FIG. 1 and that implements the process of FIG. 3, in accordance with embodiments of the present invention.

In some embodiments, the present invention may be a system, a method, and/or a computer program product. For example, a computing device 400 or the computing device 102 (of FIG. 1) is used to predict and select an optimal browser to launch a uniform resource locator (URL). The computing device 400 or the computing device 102 (of FIG. 1) is also used to control interactive surfaces, such as the user interface 112 (of FIG. 1). In an example, basic configuration 402, the computing device 400 or the computing device 102 (of FIG. 1) includes one or more processors 404 and a system memory 406. A memory bus 408 is used for communicating between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one more levels of caching, such as a level cache memory 412, an example processor core 414, and registers 416, among other examples. The example processor core 414 may include an arithmetic logic unit (ALU), a floating point unit (FPU), a digital signal processing core (DSP Core), or any combination thereof. An example memory controller 418 is used with the processor 404, or in some implementations the example memory controller 418 is an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 includes an operating system 420, one or more engines, such as a cognitive analysis engine 422, and program data 424. The cognitive analysis engine 422 includes an analysis module 427, among other engines/modules. In some embodiments, the cognitive analysis engine 422 may be a cognitive analysis application.

The analysis module 427 receives a value of a performance parameter for each browser of a plurality of browsers with respect to each species of a variable. Then, the analysis module 427 receives an assignment of the value of the performance parameter for each browser in a subset of the plurality of browsers as a mean for a cluster for a plurality of clusters of the browsers in the plurality of browsers. Next, the analysis module 427 compares a distance between the value of the performance parameter for each browser and the mean of each cluster of the plurality of clusters to identify a smallest distance between each browser and each cluster. The analysis module 427 then assigns each browser to the cluster having the smallest distance for each browser. The distance is measured using Equation 2 in paragraph 30. Then, the analysis module 427 ascertains the mean of each cluster of the plurality of clusters. The mean is calculated using Equation 1 in paragraph 29. Next, the analysis module 427 iteratively repeats the comparing step, the assigning step, and the ascertaining step for L iterations, where L is at least 1, and where L is determined as the first iteration in which the mean of each cluster of the plurality of clusters is identical to the immediately preceding mean. After the L iterations, have been performed, the analysis module 427 identifies a chosen cluster from the plurality of clusters. The chosen cluster has a lesser distance between the mean of the plurality of clusters and an origin point. Next, the analysis module 427 determines a chosen browser as having a shortest distance between each of the browsers located within the chosen cluster and the origin point. The analysis module 427 then provides, in a feedback pane on a user interface, a message to prompt a user to launch a website on the chosen browser located within the chosen cluster. Next, the analysis module 427 detects an action by the user to launch the chosen browser to display the website.

The computing device 400 or the computing device 102 (of FIG. 1) may have additional features or functionality, and additional interfaces to facilitate communications between the basic configuration 402 and any desired devices and interfaces. For example, a bus/interface controller 430 is used to facilitate communications between the basic configuration 402 and data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives, among others. Example computer storage media includes volatile and non-volatile, removable and non-removable media implemented in any method or technology for storage of information, such as computer-readable instructions, data structures, program modules, or other data.

In some embodiments, an interface bus 440 facilitates communication from various interface devices (e.g., one or more output devices 442, one or more peripheral interfaces 444, and one or more communication devices 466) to the basic configuration 402 via the bus/interface controller 430. Some of the one or more output devices 442 include a graphics processing unit 448 and an audio processing unit 450, which is configured to communicate to various external devices such as a display or speakers via one or more A/V ports 452. The one or more peripheral interfaces 444 includes a serial interface controller 454 or a parallel interface controller 456, which are configured to communicate with external devices, such as input devices (e.g., keyboard, mouse, pen, voice input device, touch input device, etc.) or other peripheral devices (e.g., printer, scanner, etc) via one or more I/O ports 458. An example of the one or more communication devices 466 include a network controller 460, which are arranged to facilitate communications with one or more other computing devices 462 over a network communication link via one or more communication ports 464. The one or more other computing devices 462 include servers, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media include wired media, such as a wired network or direct-wired connection, and wireless media, such as acoustic, radio frequency (RF), microwave, infrared (IR), and other wireless media. The term “computer-readable media,” as used herein, includes both storage media and communication media.

The system memory 406, the removable storage devices 436, and the non-removable storage devices 438 are examples of the computer-readable storage media. The computer-readable storage media is a tangible device that can retain and store instructions (e.g., program code) for use by an instruction execution device (e.g., the computing device 400 or the computing device 102 of FIG. 1). Any such, computer storage media is part of the computing device 400 or the computing device 102 (of FIG. 1).

Aspects of the present invention are described herein regarding schematic diagrams/graphs (e.g., FIG. 2A-2C), flowchart illustrations (e.g., FIG. 3) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and or block diagrams, can be implemented by the computer-readable instructions (e.g., the program code).

The computer-readable instructions are provided to the processor 404 of a general purpose computer, special purpose computer, or other programmable data processing apparatus (e.g., the computing device 400 or the computing device 102 of FIG. 1) to produce a machine, such that the instructions, which execute via the processor 404 of the computer or other programmable data processing apparatus, create means for implementing the functions/acts specified in the flowchart and/or block diagram block or blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the functions/acts specified in the flowchart and/or block diagram block or blocks.

The computer-readable instructions (e.g., the program code) are also loaded onto a computer the computing device 400 or the computing device 102 of FIG. 1), another programmable data processing apparatus, or another device to cause a series of operational steps to be performed on the computer, the other programmable apparatus, or the other device to produce a computer implemented process, such that the instructions which execute on the computer, the other programmable apparatus, or the other device implement the functions/acts specified in the flowchart and/or block diagram block or blocks.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection maybe made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer readable process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computing device 400 or the computing device 102 (of FIG. 1) may be implemented as a part of a general purpose or specialized server, mainframe, or similar computer that includes any of the above functions. The computing device 400 or the computing device 102 (of FIG. 1) may also be implemented as a personal computer including both laptop computer and non-laptop computer configurations.

Another embodiment of the invention provides a method that performs the process steps on a subscription, advertising and/or fee basis. That is, a service provider, such as a Solution Integrator, can offer to create, maintain, and/or support, etc. a process of predicting the optimal browser to launch the URL. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method executed on a computing device to select an optimal browser to launch a uniform resource locator (URL), said method comprising:
receiving, by one or more processors, a value of a performance parameter for each browser of a plurality of browsers with respect to each species of a variable;
receiving, by said one or more processors, an assignment of said value of said performance parameter for each browser in a subset of said plurality of browsers as a mean for a cluster for a plurality of clusters of said browsers in said plurality of browsers;
comparing, by said one or more processors, a distance between said value of said performance parameter for each browser and said mean of each cluster of said plurality of clusters to identify a smallest distance between each browser and each cluster;
assigning, by said one or more processors, each browser to said cluster having said smallest distance for said each browser;
ascertaining, by said one or more processors, said mean of each cluster of said plurality of clusters;
iteratively repeating, by said one or more processors, said comparing, said assigning, and said ascertaining for L iterations, wherein L is at least 1, and wherein L is determined as said first iteration in which said mean of each cluster of said plurality of clusters is identical to said immediately preceding mean;
after said L iterations have been performed,
identifying, by said one or more processors, a chosen cluster from said plurality of clusters, wherein said chosen cluster has a lesser distance between said mean of said plurality of clusters and an origin point;
determining, by said one or more processors, a chosen browser as having a shortest distance between each of said browsers located within said chosen cluster and said origin point;
providing, by said one or more processors in a feedback pane on a user interface, a message to prompt a user to launch a website on said chosen browser located within said chosen cluster; and
detecting, by said one or more processors, an action by said user to launch said chosen browser to display said website.

2. The method of claim 1, wherein said performance parameter for each browser includes: a time period required to load said URL on each browser, a length of time associated with viewing said URL on each browser, a number of errors encountered while viewing said URL on each browser, a rating of each browser obtained from members of one or more social networks, a navigation frequency associated with navigating from each browser to another browser subsequent to encountering an error loading said URL on each browser, or a combination thereof.

3. The method of claim 2, wherein said performance parameter for each browser is said number of errors encountered while viewing said URL on each browser, and wherein said errors include a networking error, a processing error, a cache error, or combinations thereof.

4. The method of claim 1, wherein said distance is measured as a Euclidean distance.

5. The method of claim 1, wherein said value of said performance parameter for each browser with respect to each species includes unweighted data points or weighted data points.

6. The method of claim 1, said method further comprising:
during said iteratively repeating, identifying, by said one or more processors, said mean of each cluster of said plurality of clusters as varying from said immediately preceding mean and in response, calculating, by said one or more processors, said distance between said value of said performance parameter for each browser and said mean of each cluster of said plurality of clusters.

7. The method of claim 6, said method further comprising:
comparing, by said one or more processors, said calculated distance between said value of said performance parameter for each browser and said mean of each cluster of said plurality of clusters to identify a smallest distance between each browser and each cluster; and
re-assigning, by said one or more processors, each browser to said cluster having said smallest distance for said each browser.

8. The method of claim 1, said method further comprising:
in response to detecting said action by said user to launch said chosen browser to display said website,
identifying, by said one or more processors, said chosen browser as uninstalled on said computing device;
prompting, by said one or more processors, in said feedback pane, said user to install said chosen browser;
detecting, by said one or more processors, another action by said user to install said chosen browser; and
detecting, by said one or more processors, an additional action by said user to launch said chosen browser to display said website.

9. The method of claim 1, said method further comprising:
storing, by said one or more processors, said performance parameter for each browser of a plurality of browsers in a repository.

10. The method of claim 9, wherein said repository includes an identify target entity repository, an opinion repository, a feedback repository, or a decision making repository.

11. A computer program product, comprising one or more computer-readable hardware storage devices having computer-readable program code stored therein, said computer-readable program code containing instructions executable by one or more processors of a computer system to implement a method for selecting an optimal browser to launch a uniform resource locator (URL), said method comprising:
receiving, by said one or more processors, a value of a performance parameter for each browser of a plurality of browsers with respect to each species of a variable;
receiving, by said one or more processors, an assignment of said value of said performance parameter for each browser in a subset of said plurality of browsers as a mean for a cluster for a plurality of clusters of said browsers in said plurality of browsers;
comparing, by said one or more processors, a distance between said value of said performance parameter for each browser and said mean of each cluster of said plurality of clusters to identify a smallest distance between each browser and each cluster;
assigning, by said one or more processors, each browser to said cluster having said smallest distance for said each browser;
ascertaining, by said one or more processors, said mean of each cluster of said plurality of clusters;
iteratively repeating, by said one or more processors, said comparing, said assigning, and said ascertaining for L iterations, wherein L is at least 1, and wherein L is determined as said first iteration in which said mean of each cluster of said plurality of clusters is identical to said immediately preceding mean;
after said L iterations have been performed,
identifying, by said one or more processors, a chosen cluster from said plurality of clusters, wherein said chosen cluster has a lesser distance between said mean of said plurality of clusters and an origin point;
determining, by said one or more processors, a chosen browser as having a shortest distance between each of said browsers located within said chosen cluster and said origin point;
providing, by said one or more processors in a feedback pane on a user interface, a message to prompt a user to launch a website on said chosen browser located within said chosen cluster; and
detecting, by said one or more processors, an action by said user to launch said chosen browser to display said website.

12. The computer program product of claim 11, wherein said performance parameter for each browser includes: a time period required to load said URL on each browser, a length of time associated with viewing said URL on each browser, a number of errors encountered while viewing said URL on each browser, a navigation frequency associated with navigating from each browser to another browser subsequent to encountering an error loading said URL on each browser, or a combination thereof.

13. The computer program product of claim 12, wherein said performance parameter for each browser is said number of errors encountered while viewing said URL on each browser, and wherein said errors include a networking error, a processing error, a cache error, or combinations thereof.

14. The computer program product of claim 11, wherein said distance is measured as a Euclidean distance.

15. The computer program product of claim 11, wherein said value of said performance parameter for each browser with respect to each species includes unweighted data points or weighted data points.

16. The computer program product of claim 11, said method further comprising:
during said iteratively repeating, identifying, by said one or more processors, said mean of each duster of said plurality of clusters as varying from said immediately preceding mean and in response, calculating, by said one or more processors, said distance between said value of said performance parameter for each browser and said mean of each cluster of said plurality of clusters.

17. The computer program product of claim 16, said method further comprising:
comparing, by said one or more processors, said distance between said value of said performance parameter for each browser and said mean of each cluster of said plurality of clusters to identify a smallest distance between each browser and each cluster; and
re-assigning, by said one or more processors, each browser to said cluster having said smallest distance for said each browser.

18. A computer system, comprising one or more processors, one or more memories, and one or more computer-readable hardware storage devices, said one or more computer-readable hardware storage devices containing program code executable by said one or more processors via said one or more memories to implement a method for selecting an optimal browser to launch a uniform resource locator (URL), said method comprising:
receiving, by said one or more processors, a value of a performance parameter for each browser of a plurality of browsers with respect to each species of a variable;
receiving, by said one or more processors, an assignment of said value of said performance parameter for each browser in a subset of said plurality of browsers as a mean for a cluster for a plurality of clusters of said browsers in said plurality of browsers;
comparing, by said one or more processors, a distance between said value of said performance parameter for each browser and said mean of each cluster of said plurality of clusters to identify a smallest distance between each browser and each cluster;
assigning, by said one or more processors, each browser to said cluster having said smallest distance for said each browser;
ascertaining, by said one or more processors, said mean of each cluster of said plurality of clusters;
iteratively repeating, by said one or more processors, said comparing, said assigning, and said ascertaining for L iterations, wherein L is at least 1, and wherein L is determined as said first iteration in which said mean of each cluster of said plurality of clusters is identical to said immediately preceding mean;
after said L iterations have been performed,
identifying, by said one or more processors, a chosen cluster from said plurality of clusters, wherein said chosen cluster has a lesser distance between said mean of said plurality of clusters and an origin point;
determining, by said one or more processors, a chosen browser as having a shortest distance between each of said browsers located within said chosen cluster and said origin point;
providing, by said one or more processors in a feedback pane on a user interface, a message to prompt a user to launch a website on said chosen browser located within said chosen cluster; and
detecting, by said one or more processors, an action by said user to launch said chosen browser to display said website.

19. The computer system of claim 18, said method further comprising:
in response to detecting said action by said user to launch said chosen browser to display said website,
identifying, by said one or more processors, said chosen browser as uninstalled on said computing device;
prompting, by said one or more processors, in said feedback pane, said user to install said chosen browser;
detecting, by said one or more processors, another action by said user to install said chosen browser; and
detecting, by said one or more processors, an additional action by said user to launch said chosen browser to display said website.

20. The computer system of claim 18, said method further comprising:
storing, by said one or more processors, said performance parameter for each browser of a plurality of browsers in a repository in a repository, wherein said repository includes an identify target entity repository, an opinion repository, a feedback repository, or a decision making repository.
